(19) United States
(12) Patent Application Publication
(10) Pub. No.: US 2010/0103444 A1
(43) Pub. Date: Apr. 29, 2010

(54) AUTOMATED PREPRESS METHODS FOR IMPROVING PAGE PARALLEL RIP PERFORMANCE

(75) Inventors: Michael E. Farrell, Webster, NY (US); David C. Robinson, Penfield, NY (US)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: XEROX CORPORATION, Norwalk, CT (US)

(21) Appl. No.: 12/258,572

(22) Filed: Oct. 27, 2008

(51) Int. Cl. G06F 3/12

(52) U.S. Cl. 358/1.15

(57) ABSTRACT

Systems and methods are presented in which a print job is segmented into multiple parts or chunks prior to facilitate raster image processing by including in each of the parts the print job preamble, one or more page portions, and only those resources required for the page portions, and the generated chunk files are provided to one or more raster image processing components for rendering or printing.

### BACKGROUND

The present exemplary embodiment relates to printing or rendering systems in which print job files are provided for printing or displaying and the print jobs are segmented into multiple files for parallel Raster Image Processing (RiPping) prior to being displayed or printed onto a printable media. This process is employed in photocopiers, fax machines, scanners, electronic displays, printers, and multi-function systems having two or more of these capabilities, and may also be used in computers and networks for rendering images for viewing. Various conventional techniques have been employed for segmenting or splitting print jobs, often for separately printing color and monochrome pages of a given print job in order to more efficiently utilize multiple print engines having different capabilities. For example, U.S. Pat. No. 6,041,200 to Glass, entitled “Method and Apparatus for Split Printing of Color And Monochrome Documents,” dated Mar. 21, 2000 describes splitting print jobs according to chromaticity, and U.S. Pat. No. 6,302,522 to Rumph, dated Oct. 16, 2001, and entitled “Performance Optimization of Monochrome Pages and Color Printing System,” describes a hardwired chromaticity splitting device within a printer, for splitting jobs between two different rendering paths within the printer. Other patents and published patent applications in this area include U.S. Pat. No. 6,327,050 to Motamed et al., entitled “Printing Method and Apparatus Having Multiple Raster Image Processors,” dated Dec. 4, 2001; U.S. Pat. No. 6,509,974 to Hansen, entitled “Automated Job Creation for Job Preparation,” dated Jan. 21, 2003; U.S. Pat. No. 7,405,836 to Hube et al., entitled “Job Submission System and Method for Controlling Multiple Job Renderings With a Single Master or ‘Super’ Ticket,” dated Jul. 29, 2008; U.S. Patent Application Publication No. US 2002/0080402 A1 to Robinson et al., entitled “Job Submission System and Method for Controlling Multiple Job Renderings With a Single Master or ‘Super’ Ticket,” dated Jun. 27, 2002; U.S. Patent Application Publication No. US 2003/0103237 A1 to Han, entitled “Device and Method for Printing Presentation Document,” dated Jun. 5, 2003; and U.S. Patent Application Publication No. US 2007/0046957 A1 to Jacobs et al., entitled “User Configured Page Chromaticity Determination and Splitting Method,” dated Mar. 1, 2007. The aforementioned patents and published patent applications are hereby incorporated by reference in their entireties as if fully set forth herein.

Job splitting applications are also commercially available, including EFI's Split or the Xerox DocuSP Color Splitter, for determining whether an object is color either by rasterizing the submission and searching the resulting image for colored pixels or by searching the page description language submission for color commands. The Xerox DocuSP color splitter solution works as follows: Via Adobe Acrobat, an input PDF is converted to a PostScript file, the PostScript file is scanned for embedded Document Structuring Convention (DSC) page boundary indicators, and, to determine chromatic content, each PostScript page is searched for certain color space operators. Job tickets for both the color and black-and-white printers are generated. The color printer job ticket is used to print the identified color pages, which are then transferred to a black-and-white printer interposer. As the black-and-white engine prints the document, the black-and-white job ticket integrates the already printed direct insert color sheets with the newly printed black-and-white pages.

### BRIEF DESCRIPTION

The present exemplary embodiment relates to a system for splitting print job files into multiple parts referred to herein as chunks for subsequent Raster Image Processing (RIPping). In the illustrated implementations, moreover, the chunk files created by this process include the print job preamble, one or more page portions, and only those resources required for the page portions of the chunk. The inventors have appreciated that conventional job file splitters produce chunks include all the resources (e.g., objects, forms, etc.) referenced by all the pages of the original job regardless of whether the resources are needed to process the page or pages included in a given chunk. As a result, the chunks produced by the conventional splitters often include unduly large amounts of overhead and thus can reduce the performance of subsequent raster image processing. In this regard, the inventors have created a technique by which parallel or even serial RiPping can be facilitated by creating the job chunk files to include only that which is needed to process the page portion(s) associated with a given chunk. This approach may be employed to advantageously avoid the additional processing and memory required in conventional splitters to copy and process a huge preamble with each chunk, especially for original job files that include a large number of pages referencing many different resources, by attempting to ensure that the created chunk files do not include large amounts of extraneous data that is not referenced or used in the chunk. Thus, the various aspects of the present disclosure may find particular utility in association with subsequent parallel RIPping systems to which the splitter provides the created chunk files for raster image processing, although parallel raster image processing is not a strict requirement of the broader aspects of the disclosure.

In accordance with one or more exemplary aspects of the disclosure, raster image processing methods are provided, including receiving a print job file having a preamble, one or more resources such as objects, forms, images, etc., and a plurality of page portions having corresponding page data, where one, some, or all of the page portions include one or more resource references to resources needed for the page. The job file in various embodiments can be in the form of a page description language (PDL) file, such as PDF, PostScript™, PCL, etc. The method also includes identifying the preamble portion of the print job file, identifying one or more page boundaries of the print job file, as well as determining a chunk size that defines the number of page portions to be included in a plurality of chunks. In certain implementations, this can be done by resolving one or more resource references within the one or more page portions of the chunk to identify resources required for the one or more page portions of the chunk. Moreover, the chunks can be created to incorporate a single page, but any integer number of page portions can be included within a given chink, and the number of pages per chunk need not be the same for each chunk. For each chunk, the method further includes determining resources required for one or more page portions of the chunk, constructing a chunk file including the preamble portion of the print job file, page data for the one or more page portions of the chunk, and only the resources determined to be required for the one or more page portions of the chunk, and providing the constructed chunk file to at least one raster image processing component. The constructed chunk files are then raster image processed (RIPped), such as by using a plurality of raster image processing components in a parallel RIP approach, although not a strict requirement of the disclosure.

Other aspects of the disclosure provide a parallel raster image processing system which is comprised of a plurality of raster image processing components individually operative to generate rasterized image files based on received chunk files, along with a splitter component. The splitter is operative to construct a plurality of chunk files based on a print job file such that the individual chunk files include a preamble portion of the print job file, page data from the print job file for one or more page portions of a chunk, and only resources determined to be required for the one or more page portions of the chunk. The splitter is also operative to provide the constructed chunk files to the plurality of raster image processing components.

Still further aspects of the disclosure provide a splitter for constructing a plurality of chunk files for subsequent raster image processing based on a print job file that includes a preamble, one or more resources, and a plurality of page portions, each page portion including corresponding page data, and at least one page portion including one or more resource references. The splitter includes a component that identifies the preamble portion of the print job file, a component that identifies one or more page boundaries of the print job file, and a component that, for each of a plurality of chunks, determines resources required for one or more page portions of the chunk and constructs a chunk file including the preamble portion of the print job file, page data for the one or more page portions of the chunk, and only the resources determined to be required for the one or more page portions of the chunk. The splitter in certain embodiments can be integrated into a printing system digital front end (DFE) to construct chunk files for subsequent raster image processing to create rasterized image files for printing by a print engine of the printing system. Alternatively, the splitter may be implemented in a computer or network or other suitable system to perform job splitting functions prior to raster image processing of the generated chunk files.

Further aspects of the present disclosure related to a computer-readable medium that includes computer-executable instructions for receiving a print job file including a preamble, one or more resources, and a plurality of page portions, each page portion including corresponding page data, and at least one page portion including one or more resource references, as well as computer-executable instructions for identifying the preamble portion of the print job file, identifying one or more page boundaries of the print job file, determining a chunk size defining a number of page portions to be included in a plurality of chunks, and for each of a plurality of chunks, determining resources required for one or more page portions of the chunk, and constructing a chunk file including the preamble portion of the print job file, page data for the one or more page portions of the chunk, and only the resources determined to be required for the one or more page portions of the chunk.

### BRIEF DESCRIPTION OF THE DRAWINGS

The present subject matter may take form in various components and arrangements of components, and in various steps and arrangements of steps. The drawings are only for purposes of illustrating preferred embodiments and are not to be construed as limiting the subject matter.

FIG. 1 is a schematic system level diagram illustrating an exemplary document processing system with an improved job splitter in accordance with one or more aspects of the present disclosure;

FIG. 2 is a schematic diagram showing further details of the printing system of FIG. 1, in which the splitter is implemented in a digital front end of the printing system together with downstream RIP processing components;

FIG. 3 is a schematic diagram illustrating another exemplary splitter implemented in a networked computer connected to the printing system in FIG. 1;

FIG. 4 is a flow diagram illustrating an exemplary method for splitting job files in accordance with further aspects of the disclosure;

FIG. 5 is a schematic diagram illustrating an exemplary DSC conformant PostScript™ print job file that can be split using the systems and methods of the present disclosure; and

FIGS. 6-8 are schematic diagrams illustrating three exemplary chunk files created by the splitters of FIGS. 1-3 from the job file of FIG. 5.

### DETAILED DESCRIPTION

Referring now to the drawing figures, several embodiments or implementations of the present disclosure are hereinafter described in conjunction with the drawings, wherein like reference numerals are used to refer to like elements throughout, and wherein the various features, structures, and graphical renderings are not necessarily drawn to scale. The disclosure relates to job file processing in which job files 80 are split into multiple chunk parts or chunks 202 to create a plurality of chunk files 300 suitable for subsequent raster image processing. In addition, the disclosure advantageously facilitates improvements in downstream RIP processing, particularly in systems utilizing page parallel RIP concepts through intelligent construction of efficient chunk files 300, such as PDF chunk files that include the resources 250 required for a page or pages 220 included in the chunk 202, but without extraneous resources not needed for the pages of the chunk. As illustrated and described below, the exemplary implementations employ splitters 9 that analyze each page of a given chunk 202 for object (resource) references 230 and resolve all external references within the scope of a page 220 by making an instance of the referenced object resource 250 in constructing the chunk file 300, while removing extraneous resources 250 so as to make each chunk file 300 self-sufficient for resources (e.g., fonts, forms, XObjects).

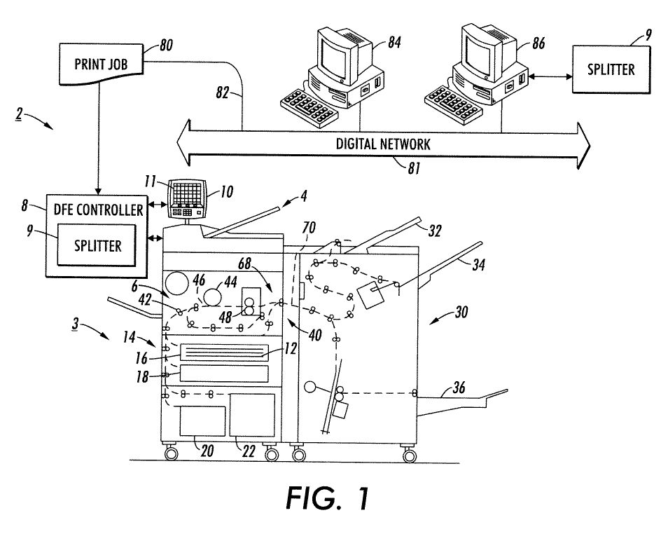

FIG. 1 illustrates an exemplary document processing or printing system 2 in which one or more exemplary aspects of the disclosure may be implemented. The printing system 2 can be any form of commercial printing apparatus, copier, printer, facsimile machine, or other system which may include a scanner or other input device 4 that scans an original document text and/or images to create an image comprising pixel values indicative of the colors and/or brightness of areas of the scanned original, or receives images such as in a print job 80, and which has at least one marking engine or print engine 6 by which visual images, graphics, text, etc. are printed on a page or other printable medium, including xerographic, electro photographic, and other types of printing technology, wherein such components are not specifically illustrated in FIG. 1 to avoid obscuring the various aspects of the present disclosure. The print engine 6 in the system of FIG. 1 may be any device or marking apparatus for applying an image from a digital front end (DFE) printer job controller 8 to printable media (print media) such as a physical sheet of paper, plastic, or other suitable physical media substrate for images, whether precut or web fed, where the input device 4, print engine 6, and controller 8 are interconnected by wired and/or wireless links for transfer of electronic data therebetween, including but not limited to telephone lines, computer cables, ISDN lines, etc. The print engine 6 generally includes hardware and software elements employed in the creation of desired images by electrophotographic processes wherein suitable print engines 6 may also include ink-jet printers, such as solid ink printers, thermal head printers that are used in conjunction with heat sensitive paper, and other devices capable of printing or marking an image on a printable media.

The image input device 4 may include or be operatively coupled with conversion components for converting the image-bearing documents to image signals or pixels or such function may be assumed by the printing engine 6. The system 2 includes an integral user interface 10 with a display 11 and suitable operator/user controls such as buttons, touch screen, etc. The DFE printer controller 8 provides the output pixel data from memory to a print engine 6 that is fed with a print media sheets 12 from a feeding source 14 such as a paper feeder which can have one or more print media sources or paper trays 16, 18, 20, 22, each storing sheets of the same or different types of print media 12 on which the marking engine 6 can print. The exemplary print engine 6 includes an imaging component 44 and an associated fuser 48, which may be of any suitable form or type, and may include further components which are omitted from the figure so as not to obscure the various aspects of the present disclosure. In one example, the print engine 6 may include a photoconductive insulating member or photoreceptor which is charged to a uniform potential via a corotron and exposed to a light image of an original document to be reproduced via an imaging laser under control of a controller of the DFE 8, where the exposure discharges the photoconductive insulating surface of the photoreceptor in exposed or background areas and creates an electrostatic latent image on the photoreceptor corresponding to image areas of the original document. The electrostatic latent image on the photoreceptor is made visible by developing the image with an imaging material such as a developing powder comprising toner particles via a development unit, and the customer image is then transferred to the print media 12 and permanently affixed thereto in the fusing process.

In a multicolor electrophotographic process, successive latent images corresponding to different colors can be formed on the photoreceptor and developed with a respective toner of a complementary color, with each color toner image being successively transferred to the paper sheet 12 in superimposed registration with the prior toner image to create a multi-layered toner image on the printed media 12, and where the superimposed images may be fused contemporaneously, in a single fusing process. The fuser 48 receives the imaged print media from the image-forming component and fixes the toner image transferred to the surface of the print media 12, where the fuser 48 can be of any suitable type, and may include fusers which apply heat or both heat and pressure to an image. Printed media from the printing engine 6 is delivered to a finisher 30 including one or more finishing output destinations 32, 34, 36 such as trays, stackers, pans, etc. A print media transporting system or network or highway 40 of the document processing system 2 links the print media source 14, the print engine 6, and the finisher 30 via a network of flexible automatically feeding and collecting drive members, such as pairs of rollers 42, spherical nips, air jets, or the like, along with various motors for the drive members, belts, guide rods, frames, etc. (not shown), which, in combination with the drive members, serve to convey the print media 12 along selected pathways at selected speeds. Print media 12 is thus delivered from the source 14 to the print engine 6 via a pathway 46 common to the input trays 16, 18, 20, 22, and is printed by the imaging component 44 and fused by the fuser 48, with a pathway 46 from the print engine 6 merging into a pathway 70 which conveys the printed media 12 to the finisher 30, where the pathways 46, 48, 70 of the network 40 may include inverters, reverters, interposers, bypass pathways, and the like as known in the art. In addition, the print engine 6 may be configured for duplex or simplex printing and a single sheet of paper 12 may be marked by two or more print engines 6 or may be marked a plurality of times by the same marking engine 6, for instance, using internal duplex pathways (not shown).

The document processing system 2 is operative to perform these scanning and printing tasks in the execution of print jobs 80, which can include printing selected text, line graphics, images, machine ink character recognition (MICR) notation, etc., on either or both of the front and back sides or pages of one or more media sheets 12. An original document or image or print job or jobs 80 can be supplied to the printing system 2 in various ways. In one example, the built-in optical scanner 4 may be used to scan an original document such as book pages, a stack of printed pages, or so forth, to create a digital image of the scanned document that is reproduced by printing operations performed by the printing system 2 via the print engine 6. Alternatively, the print jobs 80 can be electronically delivered to the system controller 8 via a network 81 or other means, for instance, whereby a network user can print a document from word processing software running on a network computer 84, 86 thereby generating an input print job 80. The print engine 6, the DFE 8, and the finishing station 30 in the illustrated example are part of a printing machine 3, wherein a splitter 9 is implemented in the exemplary DFE 8, and another splitter 9 is implemented in the networked computer 86, although the splitter can be implemented in any suitable host to generate chunk files 300 for subsequent RIP processing and the specific location of the splitter 9 is not a strict requirement of the present disclosure. In the implementation of FIG. 1, moreover, the printing machine 3 is operatively coupled to the digital network 81 via a digital connection 82 and the terminals 84, 86 are connected to the digital network 81. In these embodiments, the digital network 81 may of any suitable form or type, including without limitation Ethernet, fiber optic, wireless, Bluetooth, or any combination thereof, and the terminals 84, 86 include a capability of sending a print job 80 and/or chunk files 300 via the digital network 81 to the printing machine 3.

The splitter 9 any component thereof, whether implemented in the DFE controller 8 or in a networked computer 84, 86 operatively associated with the printing system 2, may be any suitable hardware, software, firmware, logic, or combinations thereof that are adapted, programmed, or otherwise configured to implement the functions illustrated and described herein, and may be embodied as computer-executable instructions of a computer-readable media, such as in memory of the computer 86, the DFE 8, or other memory storage media operatively coupled with a computer for execution of such instructions. For example, the controller 8 and the splitter 9 in certain embodiments may be implemented, in whole or in part, as software components and may be implemented as a set of sub-components or objects including computer-executable instructions of a memory, disk, or other computer-readable media that can be executing on one or more hardware platforms such as one or more computers including one or more processors, data stores, memory, etc. of the system 2, or the splitter 9 may be computer-executable instructions executing in one of the computers 84, 86. The splitter 9, moreover, and components thereof, may be executed on the same computer or processor, or may be implemented in distributed fashion in two or more processing components that are operatively coupled with one another to provide the functionality and operation described herein.

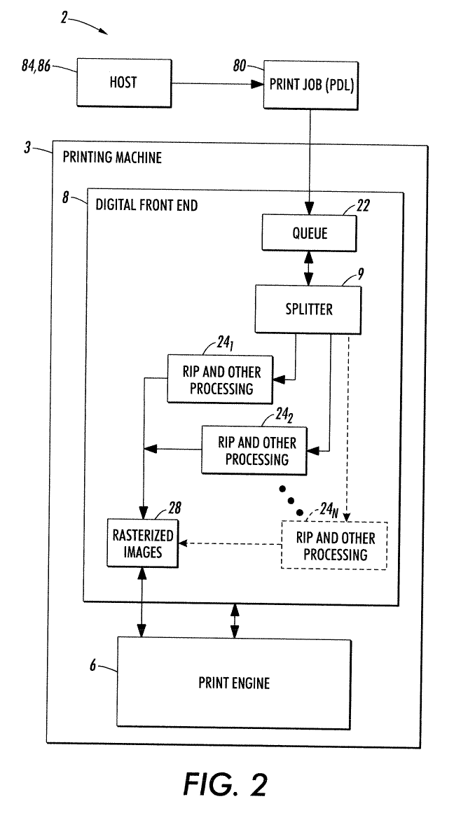

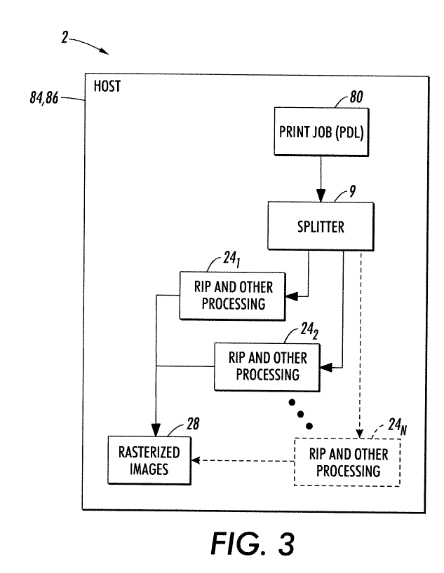

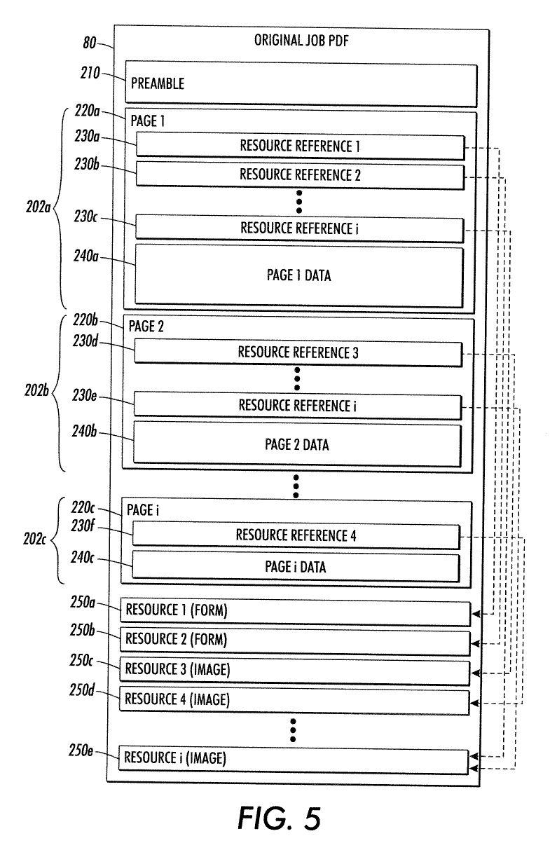

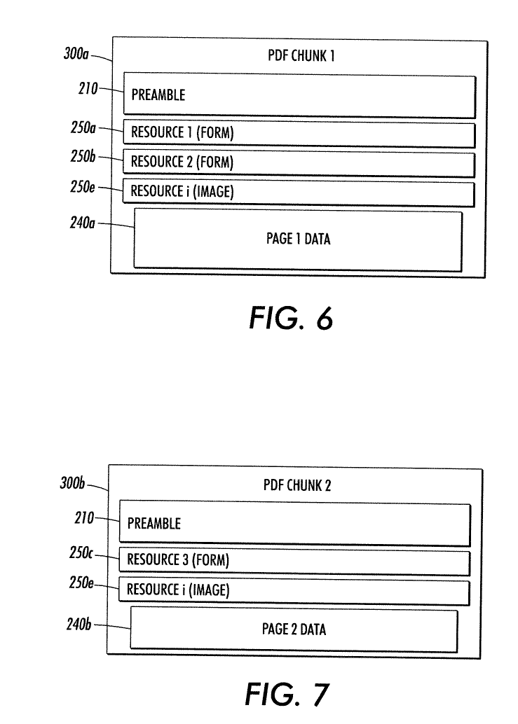

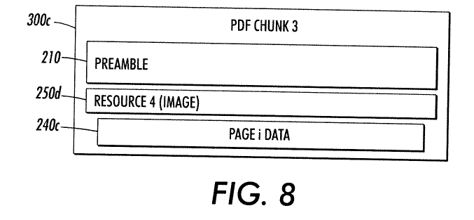

Referring also to FIGS. 2 and 3, in operation, the splitter 9, whether in the DFE 8 or in the computer 86, receives print job files 80, such as a PDL file 80 (e.g., PDF, PostScript™, etc., FIG. 5 below), and from this constructs a plurality of chunk files 300 (e.g., FIGS. 6-8 below) for subsequent raster image processing. FIG. 2 illustrates in greater detail one example of the splitter 9 implemented in the DFE 8 and FIG. 3 shows an implementation of the splitter 9 in one of the host computers 84, 86. As depicted in these figures, the exemplary splitter 9 is situated to receive and process incoming print job files 80 and to provide generated chunk files to one or more downstream RIP processing components 24. In these examples, the print job files 80 can be received from any suitable source (e.g., the DFE-based splitter implementation 9 in FIG. 2 may receive incoming print jobs 80 via a queue 22 from one of the host computers 84, 86 via the network 81. In another example, the host-based splitter 9 (FIG. 3) is implemented on a PC platform and may receive print jobs 80 from various entities connected to the network 81 or these may be generated by application programs running on the computer 84, 86. As shown in FIG. 3, moreover, the host computer 84, 86 and the DFE 8 may also include one or more RIP components 24, wherein any positive integer number ‘N’ such RIP processing components may be employed to create rasterized images 28 for printing via a print engine 6 or for other rendering, such as displaying the images on a computer 84, 86, or for other purposes.

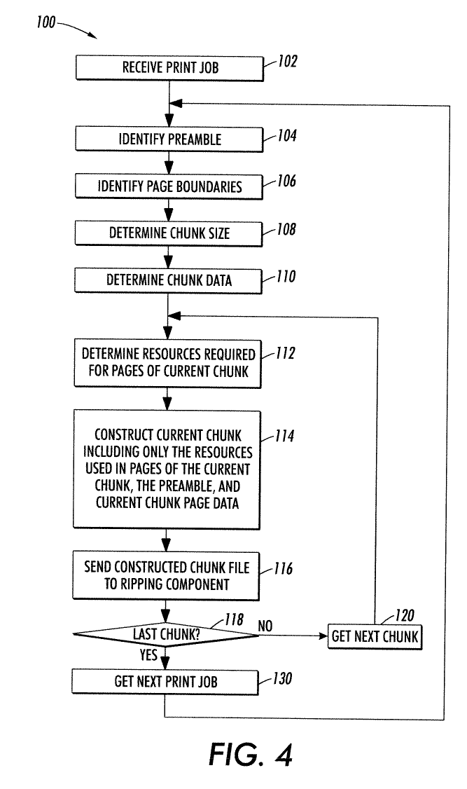

Referring also to FIGS. 4-8, the exemplary splitter 9 may perform various processing tasks and functions to implement splitting of the job files 80 into chunk files 300, and may include various components. FIG. 4 provides a flow diagram 100 illustrating the basic operation of the splitter 9 in implementing pre-RIP splitting of incoming print job files 80. FIG. 5 illustrates an exemplary DSC conformant PostScript™ print job file 80 that includes a preamble 210, one or more resources 250a-250e (e.g., fonts, forms, XObjects, images, etc.), and “i” page portions 220, where “I” is an integer greater than 1, with only three exemplary page portions 220a-220c being illustrated in the figure. The various portions of the job file may be anywhere within the file 80, for example, where the resources 250 may be separate from the preamble 210, or may be integrated into the preamble 210. Each page portion 220 of the job file 80 includes corresponding page data 240, and one or more of the page portions 220 includes at least one resource reference 230. The references 230 in one embodiment are provided as a cross-reference table, in the page portions 220 that can be used to store pointer references 230 that index to locations of resources 250 in the original job file 80. One possible implementation of the splitter 9 includes a component that identifies the preamble 210 and a component that identifies one or more page boundaries of the print job file 80, as well as a component that, for each of a plurality of chunks 202 identified in the job file 80, determines which of the resources 250 is required for the page or pages 220 of a given chunk 202, and which constructs a chunk file 300 (FIGS. 6-8) that includes the preamble 210, the corresponding page data 240, and only those resources 250 determined to be required for the one or more page portions 220 of the chunk 202.

The flow diagram in FIG. 4 illustrates an exemplary method 100 in accordance with the present disclosure, which illustrates the operation of the splitter 9. While the exemplary method 100 is illustrated and described below in the form of a series of acts or events, it will be appreciated that the various methods of the disclosure are not limited by the illustrated ordering of such acts or events. In this regard, except as specifically provided hereinafter, some acts or events may occur in different order and/or concurrently with other acts or events apart from those illustrated and described herein in accordance with the disclosure. It is further noted that not all illustrated steps may be required to implement a process or method in accordance with the present disclosure, and one or more such acts may be combined. The illustrated method 100 of the disclosure may be implemented in hardware, software, or combinations thereof, such as in the exemplary splitter 9 of the DFE 8 or in the host computers 84, 86 in FIGS. 1-3 above, and may be embodied in the form of computer-executable instructions stored in a computer-readable medium, such as in a memory operatively associated with the controller 8 and/or the computers 84, 86.

At 102 in FIG. 4, the print job file 80 is received by the splitter 9. The splitter 9 identifies the preamble 210 at 104 and identifies one or more page boundaries in the file 80 at 106. A chunk size is determined at 108 for each prospective chunk file 300, where the size may vary from chunk to chunk and may be derived from an external source or may be generated by the splitter 9. For example, the chunk size may be expressed as a number of page portions 220 to be included in each chunk 202, or may be a series of numbers representing the numbers of page portions 220 in a series of chunks 220. In the example shown in FIG. 5, for instance, each chunk 220 includes a single page portion 220, although this is not a requirement of the present disclosure.

At 110, the data for a first chunk is obtained for constructing a first chunk file 300 (e.g., to create chunk file 300a in FIG. 6), and the page or pages of the current chunk 202 are analyzed for extraneous objects, such as those objects (resource references 250) not used on the chunk page(s), and these are removed from the page references 230. At 112 in the exemplary flow diagram 100, the splitter determines which resources are required for the one or more pages 220 of the current chunk 202. The inventors have appreciated that this may advantageously benefit the subsequent RIP processing compared with conventional splitting techniques in which the splitter merely parsed the remainder of the file only well enough to identify page boundaries. In the illustrated embodiment, the determination at 112 includes resolving one or more resource references 230 within the one or more page portions 220 of the current chunk 202 in order to identify those resources 250 that are required for the one or more page portions 220, with any extraneous or unneeded resources 250 being omitted from the constructed chunk file 300.

At 114, the splitter 9 constructs the current chunk file 300 including the preamble portion 210 of the print job file 80, page data 240 for the one or more page portions 220 of the chunk 202, and only the resources 250 determined at 112 to be required. As shown in the exemplary first chunk file 300a in FIG. 6, this results in an economized chunk file having only the form and image resources 250a, 250b, and 250i needed for the first page portion 220a. At 116, the constructed chunk file 300 is sent to a raster image processing component 24, and a determination is made at 118 as to whether the current chunk is the last one in the job file 80. If not (NO at 118), the process 100 returns to get the next chunk 202 at 120 and proceeds to 112 as described above. Otherwise, (YES at 118), the next print job file 80 (if any) is obtained at 130 and the method 100 returns to 104 as described above. The constructed chunk files 300 in the examples of FIGS. 1-3 are RIP processed by the raster image processing components 24 to generate print-ready rasterized images 28 that can be stored and/or printed or otherwise rendered.

The above examples are merely illustrative of several possible embodiments of the present disclosure, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (i.e., that is functionally equivalent), even though not structurally equivalent to the disclosed structure which performs the function in the illustrated implementations of the disclosure. In addition, although a particular feature of the disclosure may have been disclosed with respect to only one of several embodiments, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”. It will be appreciated that various of the above-disclosed and other features and functions, or alternatives thereof, may be desirably combined into many other different systems or applications, and further that various presently unforeseen or unanticipated alternatives, modifications, variations or improvements therein may be subsequently made by those skilled in the art which are also intended to be encompassed by the following claims.

1. A method for raster image processing a print job, the method comprising:
receiving a print job file including a preamble, one or more resources, and a plurality of page portions, each page portion including corresponding page data, and at least one page portion including one or more resource references;
identifying the preamble portion of the print job file;
identifying one or more page boundaries of the print job file;
determining a chunk size defining a number of page portions to be included in a plurality of chunks;
for each of a plurality of chunks:
determining resources required for one or more page portions of the chunk,
constructing a chunk file including the preamble portion of the print job file, page data for the one or more page portions of the chunk, and only the resources determined to be required for the one or more page portions of the chunk, and
providing the constructed chunk file to at least one raster image processing component; and
raster image processing the constructed chunk files.

2. The method of claim 1, wherein determining resources required for one or more page portions of the chunk comprises resolving one or more resource references within the one or more page portions of the chunk to identify resources required for the one or more page portions of the chunk.

3. The method of claim 1, wherein the print job file is in a page description language.

4. The method of claim 3, wherein the print job file is a DSC conformant PostScript™ file or a PDF file.

5. The method of claim 1, wherein the constructed chunk files are raster image processed using a plurality of raster image processing components.

6. A parallel raster image processing system, comprising:
a plurality of raster image processing components individually operative to generate rasterized image files based on received chunk files; and
a splitter component operative to construct a plurality of chunk files based on a print job file, the individual chunk files including a preamble portion of the print job file, page data from the print job file for one or more page portions of a chunk, and only resources determined to be required for the one or more page portions of the chunk, the splitter being operative to provide constructed chunk files to the plurality of raster image processing components.

7. The system of claim 6, the splitter component being operative to identify the preamble portion of the print job file, to identify one or more page boundaries of the print job file, to determine a chunk size defining a number of page portions to be included in each chunk file, and for each chunk to determine resources required for one or more page portions of the chunk, construct a chunk file including the preamble portion of the print job file, page data for the one or more page portions of the chunk, and only the resources determined to be required for the one or more page portions of the chunk.

8. The system of claim 6, wherein the splitter component is operative to resolve one or more resource references within the one or more page portions of the chunk to identify the resources required for the one or more page portions of the chunk.

9. A splitter for constructing a plurality of chunk files for subsequent raster image processing based on a print job file that includes a preamble, one or more resources, and a plurality of page portions, each page portion including corresponding page data, and at least one page portion including one or more resource references, the splitter comprising:
a component that identifies the preamble portion of the print job file;
a component that identifies one or more page boundaries of the print job file;
a component that, for each of a plurality of chunks, determines resources required for one or more page portions of the chunk and constructs a chunk file including the preamble portion of the print job file, page data for the one or more page portions of the chunk, and only the resources determined to be required for the one or more page portions of the chunk.

10. The splitter of claim 9, wherein the print job file is in a page description language.

11. The splitter of claim 9, wherein the splitter is integrated into a digital front end of a printing system and operative to construct chunk files for subsequent raster image processing to create rasterized image files for printing by a print engine of the printing system.

12. A computer-readable medium comprising computer-executable instructions for:
receiving a print job file including a preamble, one or more resources, and a plurality of page portions, each page portion including corresponding page data, and at least one page portion including one or more resource references;
identifying the preamble portion of the print job file;
identifying one or more page boundaries of the print job file;
determining a chunk size defining a number of page portions to be included in a plurality of chunks;
for each of a plurality of chunks:
determining resources required for one or more page portions of the chunk, and
constructing a chunk file including the preamble portion of the print job file, page data for the one or more page portions of the chunk, and only the resources determined to be required for the one or more page portions of the chunk.

13. The computer-readable medium of claim 12, further comprising computer-executable instructions for providing the constructed chunk file to at least one raster image processing component, and raster image processing the constructed chunk files.

14. The computer-readable medium of claim 12, further comprising computer-executable instructions for resolving one or more resource references within the one or more page portions of the chunk to identify resources required for the one or more page portions of the chunk.
